(19) United States
(12) Patent Application Publication
(10) Pub. No.: US 2006/0260730 A1
(43) Pub. Date: Nov. 23, 2006

(54) Pneumatic tyre for two wheeled vehicles

(76) Inventors: Pierangelo Misani, Monza (IT); Maurizio Marchini, Seregno (IT); Fiorenzo Mariani, Biassono (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/546,483

(22) PCT Filed: Mar. 26, 2003
(86) PCT No.: PCT/IB03/01092

§ 371 Date: Jul. 11, 2006

(51) Int. Cl. B60C 9/00

(52) U.S. Cl. 152/531; 152/559; 152/532; 152/558

(57) ABSTRACT

A pneumatic tyre for a two-wheeled vehicle includes a carcass structure, belt structure, tread band, and pair of sidewalls. The carcass structure includes at least one first and second carcass ply. Each carcass ply includes cords disposed substantially parallel to each other. Ends of each carcass ply are engaged with respective circumferential annular reinforcing structures. Each carcass ply cord identifies a radial plane of the tyre passing through an intersection point of the cord with an equatorial plane of the tyre and lies in a plane substantially perpendicular to the equatorial plane and forming a lying angle different from zero with a respective radial plane. The lying angle of each cord of the at least one first carcass ply and the lying angle of a corresponding cord of the at least one second carcass ply identifying a same radial plane have opposite signs with respect to that radial plane.

The present invention relates to a pneumatic tyre in particular adapted to equip two-wheeled vehicles.

It is known that a tyre generally comprises: a carcass structure provided with at least one carcass ply the ends of which are in engagement with respective circumferential annular reinforcing structures integrating annular elements usually called “bead cores”; a belt structure applied at a radially external position with respect to the carcass structure; a pair of sidewalls applied at an axially external position to side surfaces of the carcass structure and each extending radially away from one of the annular anchoring structures towards said belt structure; a tread band usually consisting of a strip of elastomer material of appropriate thickness applied at a radially external position to the belt structure and in which, following a moulding operation carried out concurrently with tyre vulcanisation, longitudinal and/or transverse grooves are formed that are such disposed as to define a desired “tread pattern”.

The carcass structure may possibly be coated on its inner walls with an air-tight layer generally called “liner” and essentially consisting of a layer of elastomer material impervious to air that in tubeless tyres is adapted to ensure the hermetic seal of the tyre itself once it has been inflated.

In the so-called “radial” tyres each of the cords arranged in the carcass ply or plies lies in a plane substantially radial to the tyre rotation axis, i.e. it has an orientation substantially orthogonal to the circumferential extension direction. In a different manner, in the so-called “cross-ply” tyres, the carcass structure generally comprises at least one carcass ply having obliquely oriented cords with respect to the circumferential extension direction of the tyre, and a second carcass ply the cords of which have an orientation extending obliquely and symmetrically crossed with respect to the cords of the first ply.

Presently, most of the tyres are of the radial type because, with respect to tyres of the cross-ply type, they offer important advantages in terms of lightness-in-weight, ride comfort and structural strength at high speeds.

In accordance with recent production processes, as depicted in document EP 928 680 in the name of the same Applicant for example, a tyre can be directly built on a toroidal support. A first carcass ply is formed by laying elongated sections or “strip-like elements” onto said toroidal support, each of said strip-like elements comprising longitudinal thread-like elements incorporated in a layer of elastomer material. Said strip-like elements are laid down sequentially so as to form a carcass structure in which the strip-like elements are partly overlapped at side portions of the tyre and disposed circumferentially close to each other at the crown region of the tyre itself. Associated with the carcass ply are annular reinforcing structures comprising a first and a second circumferential annular insert for example, and an elastomer filler interposed therebetween. A second carcass ply can be made in superposed relationship with the first carcass ply and with said annular structures. Then a belt structure is associated with the carcass structure thus formed, said belt structure being also made by deposition of strip-like elements. Subsequently a tread band and a pair of sidewalls are applied by superposition of an elementary semifinished product of elastomer material in the form of a elongated element of appropriate sizes so as to form coils disposed in axial side by side and/or radial superposition relationship. This process then contemplates use of at least two different types of elementary semifinished products, namely: the elongated element, i.e. a section member of elastomer material alone of a substantially rectangular section; the strip-like element, i.e. a strip of elastomer material into which elongated reinforcing elements are incorporated, typically textile or metallic cords.

WO 00/38906 in the name of the same Applicant illustrates a method of producing a tyre in which a carcass ply is formed by laying a first and a second series of sections alternated with one another onto a toroidal support, said sections having side portions terminating on opposite sides with respect to first primary portions of annular reinforcing structures to the beads. Subsequently, a second ply is formed in the same manner as the first ply, with a third and a fourth series of elongated sections superposed on opposite sides on second primary portions of the annular reinforcing structures. The sections forming the first and second carcass plies are laid down in respective deposition planes offset in parallel on opposite sides with respect to a meridian plane of the toroidal support and have mutually-crossing side portions and radially-disposed crown portions.

Tyres for two-wheeled vehicles, as compared with tyres for four-wheeled vehicles, require quite particular performance involving many structural differences. The most important differences arise from the fact that during running on a curve a motorcycle must be greatly inclined with respect to its position during a straight run, thereby forming an angle (called camber angle) usually of 45° with the perpendicular to the ground but which may also reach 65° under extreme drive conditions. Therefore, when the motorcycle is facing a curve, the ground-contact area of the tyre progressively moves from the central region of the tread to the axially outermost region in the direction of the curve centre. For the above reason tyres for two-wheeled vehicles are distinguishable due to their marked transverse curvature. This transverse curvature is usually identified by the particular value of the ratio of the distance between the radially outermost point of the tread and the line passing through the laterally opposite extremities of the same tread measured in the equatorial plane of the tyre, to the distance measured along the tyre chord between said extremities. In tyres for two-wheeled vehicles, the curvature ratio value is generally at least as high as 0.15 and usually is in the order of about 0.3 for rear tyres and higher, even until reaching about 0.45, for front tyres, against a value usually in the order of 0.05 in motor-vehicle tyres.

Presently, tyres for two-wheeled vehicles usually have a radial carcass structure associated with a belt structure that may comprise one or more belt layers in the form of a closed ring, essentially consisting of textile or metallic cords suitably oriented with respect to the cords belonging to the adjacent carcass structure.

In particular, the belt structure can be formed of one or more continuous cords wound up into coils disposed axially close to each other and substantially parallel to the circumferential extension direction of the tyre itself (the so-called “zero-degree belt”). Alternatively, the belt structure may consist of two radially superposed layers, each consisting of elastomer material reinforced with cords disposed parallel to each other, said layers being arranged in such a manner that the cords of the first belt layer are obliquely oriented with respect to the equatorial plane of the tyre, whereas the cords of the second layer have an oblique orientation too but they are symmetrically crossed with respect to the cords of the first layer (the so-called “cross belt”).

It is the Applicant's feeling that tyres for two-wheeled vehicles having a crossed belt are characterised by a high bending rigidity in the region taken up by the tread band, which ensures an excellent behaviour on a curve. However, since the lateral rigidity at the sidewalls is relatively low as compared with the high bending rigidity in the tread band region, vibrations may arise during a straight running that may reduce the vehicle steadiness at high speed.

On the contrary, in tyres for two-wheeled vehicles with a zero-degree belt, the bending rigidity in the tread band region is not substantially increased, so that during a straight run, in particular at high speed, vibrations are controlled and the grip with the ground is improved. However, when a tyre is run on a curve the lateral rigidity may be insufficient and in addition in case of two-wheeled vehicles of big sizes, transmission of the torque to the ground by the tyre may decrease. In an attempt to combine an optimal behaviour both during a straight run and on a curve, tyres for two-wheeled vehicles have been proposed in which the belt structure combines a zero-degree spiralling with a pair of crossed layers. Seldom these embodiments have brought to a real balancing of the tyre behaviour, and at all events they involve a greater construction complexity and an important weight increase (as shown in document GB 2 157 239).

The Applicant has therefore become aware of the necessity of improving the tyre behaviour on a curve for two-wheeled vehicles, in particular of big sizes, while maintaining comfort and steadiness on a straight run and without involving a weight increase.

The Applicant has found that said problem can be solved by making a tyre which has a carcass structure comprising at least two plies, in which the cords of both plies lie in a plane substantially perpendicular to the equatorial plane of the tyre and forming a lying angle with the corresponding radial plane different from zero, the cords of the first carcass ply having a lying angle of different sign than the lying angle of the cords belonging to the second carcass ply with respect to the same radial plane. In this way the cords of the plies of which the carcass structure is made gradually cross as they proceed axially along the tread band and radially along the sidewalls. Therefore the resulting carcass structure is substantially of radial type in the central region around the equatorial plane and substantially of the cross-ply type in the lateral portions at the sidewalls.

A carcass structure thus built ensures a high longitudinal flexibility, so that the tyre is provided with excellent qualities of direction stability and high capability of absorbing the disturbing energy resulting from ground unevenness, thereby mitigating the so-called “kick-back” phenomenon. At the same time, gradual crossing of the cords of the two carcass plies ensures a gradual increase of the resistance to slip thrusts in the tyre in accordance with the present invention, upon increasing of the camber angle, which will bring about an improvement in the stability and drive precision when the tyre is run on a curve.

These features are accompanied by an improved structural resistance to torsional stress to which the tyre is submitted during the accelerating and braking steps.

As better illustrated in the following, this quality is particularly advantageous when the belt structure is made up of one or more continuous cords spiralled along a direction substantially parallel to the equatorial plane of the tyre. In fact this belt structure enables the advantageous combination of features of the carcass structure during a straight run and on a curve, as above illustrated, to be enhanced at the most without making the overall structure of the tyre heavier.

In a first aspect the invention relates to a tyre for two-wheeled vehicles comprising: a carcass structure having at least one first carcass ply and at least one second carcass ply, each carcass ply comprising a plurality of cords disposed substantially parallel to each other, said plies being substantially shaped in a toroidal configuration and having their ends in engagement with respective circumferential annular reinforcing structures; a belt structure applied at a radially external position to said carcass structure; a tread band applied at a radially external position to said belt structure; a pair of sidewalls laterally applied on opposite sides relative to said carcass structure; in which each cord of said carcass plies: identifies a radial plane of said tyre passing through the intersection point of said cord with the equatorial plane of the tyre; and lies in a lying plane substantially perpendicular to the equatorial plane of the tyre and forming a lying angle different from zero with said radial plane; and in which the lying angle of each cord of said at least one first carcass ply and the lying angle of a corresponding cord of said at least one second carcass ply identifying the same radial plane have opposite signs with respect to said radial plane.

In a preferred aspect, the lying angle of each cord of said at least one first carcass ply and the lying angle of a corresponding cord of said at least one second carcass ply identifying the same radial plane have opposite signs relative to said radial plane and a substantially identical absolute value.

In a further preferred aspect, said belt structure comprises a layer having a plurality of circumferential coils disposed in axial side by side relationship and spirally wound up with a substantially zero-degree angle relative to said equatorial plane of said tyre.

Further features and advantages of the invention will become more apparent from the detailed description of some preferred but not exclusive embodiments of a tyre for two-wheeled vehicles in accordance with the present invention. This description will be set out hereinafter with reference to the accompanying drawings given by way of non-limiting example, in which:

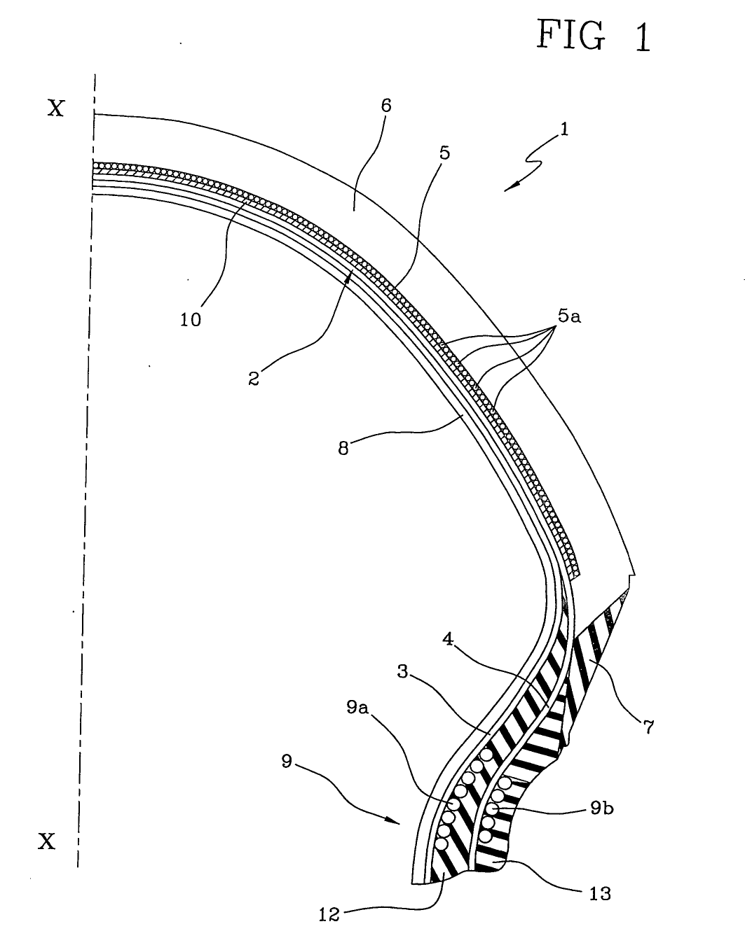

FIG. 1 is a partial sectional view of a tyre in accordance with the invention;

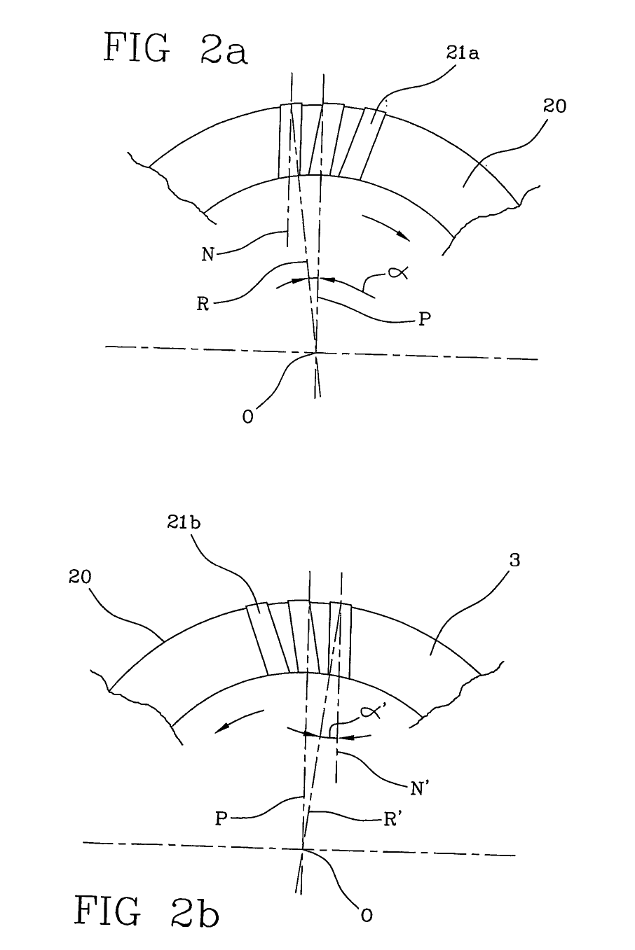

FIG. 2A is a partial side view of a portion of carcass structure belonging to a first carcass ply during building of same on a rigid toroidal support;

FIG. 2B is a partial side view of a portion of carcass structure belonging to a second carcass ply during building of same on a rigid toroidal support;

FIG. 2C is a partial side view showing a strip-like element of a first carcass ply and a strip-like element of a second carcass ply when laying of same onto a rigid toroidal support has been completed, which strip-like elements have a cord identifying the same radial plane;

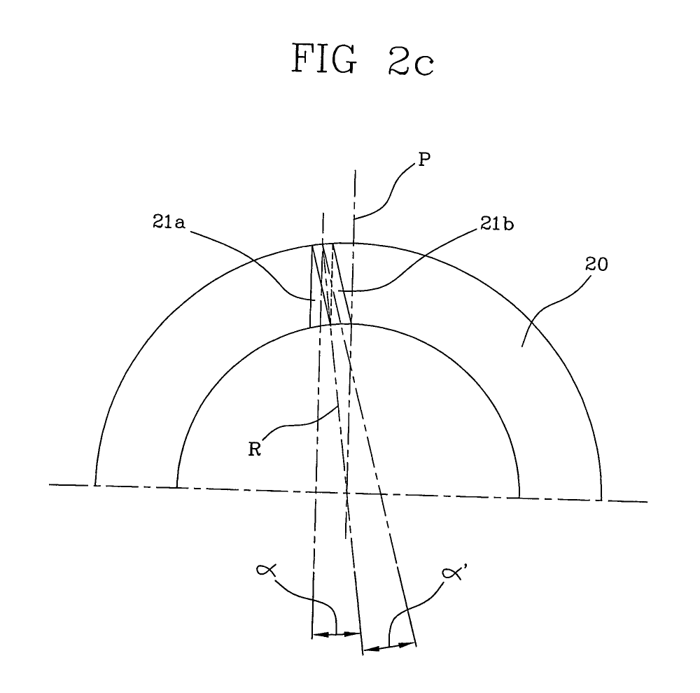

FIG. 3 is a fragmentary side view of a two-ply carcass structure belonging to the tyre in reference;

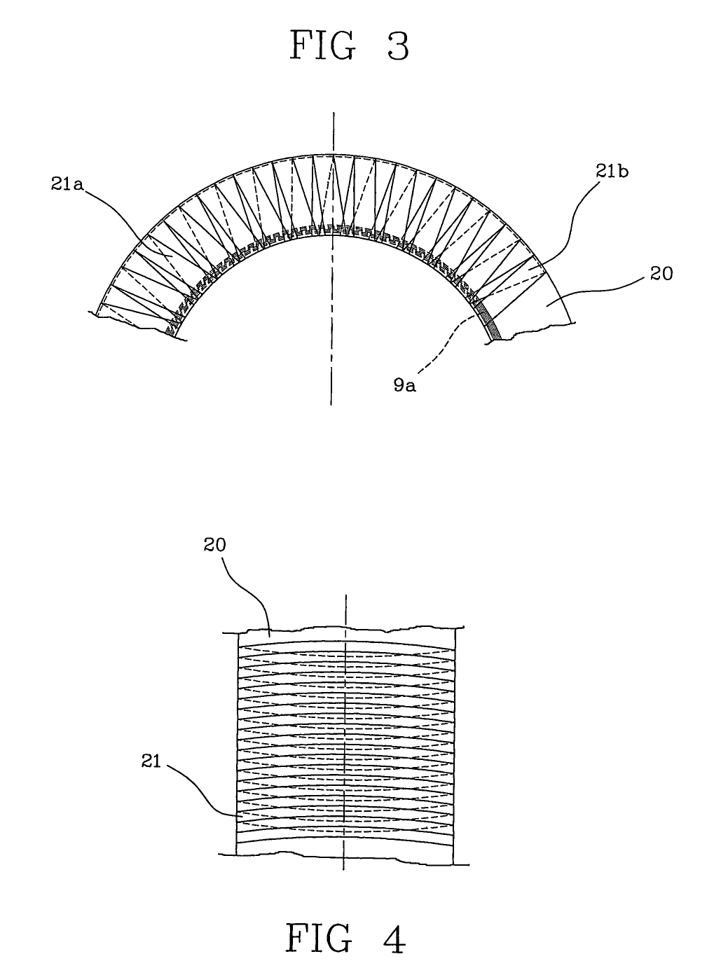

FIG. 4 is a view of a portion of the carcass structure shown in FIG. 3 developed in a horizontal plane.

With reference to the drawings, a tyre for two-wheeled vehicles has been generally identified by reference numeral 1; it comprises a carcass structure 2 preferably having a first and a second carcass plies 3, 4, shaped in a substantially toroidal configuration and each in engagement, through the opposite circumferential edges thereof, with at least one annular reinforcing structure 9 so as to form a structure usually identified as the “bead”.

Circumferentially applied to the carcass structure 2, at a radially external position, is a belt structure 5, on which a tread band 6 is circumferentially superposed; formed into said tread band 6, following a moulding operation carried out concurrently with the tyre vulcanisation, are longitudinal and transverse grooves such disposed as to define a desired “tread pattern”.

Tyre 1 also comprises a pair of sidewalls 7 laterally applied to the carcass structure 2 on opposite sides.

The carcass structure 2 may be possibly coated at its inner walls, with an air-tight layer 8, a so-called “liner”, which essentially consists of a layer of elastomer material impervious to air and adapted to ensure a hermetic seal to the tyre once inflated.

Preferably, the belt structure 5 comprises a layer having a plurality of circumferential coils 5a disposed in axial side by side relationship, formed of a rubberised cord or of a strip-like element comprising some (preferably 2 to 5) rubberised cords, wound into coils with an angle of substantially zero degrees relative to the equatorial plane of the tyre. In other words, said cords form a plurality of circumferential coils 5a, substantially oriented towards the rolling direction of the tyre usually referred to as “zero-degree arrangement with reference to the position relative to the equatorial plane X-X of tyre 1.

In a preferred embodiment, the circumferential coils are wound on said carcass structure 2 according to a variable pitch so as to preferably obtain a greater density of the cords on the opposite side portions than on the central portion of the belt structure 5.

It is to be considered here and in the following that even if spiralling as well as any pitch variation may give rise to deposition angles different from zero, these angles are so small that they can be always considered substantially of zero value.

Generally said cords are textile or metallic cords. Preferably said cords are cords made of steel having such a behaviour that in a stress-deformation diagram said cords have a percent elongation exceeding 0.4%, more preferably included between 0.5 and 4%, with a load lower than 5% with respect to the tensile strength.

Preferably said cords are made of high-carbon steel wires (HT), i.e. steel wires containing more than 0.9% carbon.

If textile cords are used, said cords can be made of synthetic fibre, such as nylon, rayon, PEN, PET, preferably a high-modulus synthetic fibre, in particular aramidic fibre (Kevlar® fibres, for example). Alternatively, hybrid cords can be employed which comprise at least one low-module thread (a nylon or rayon thread, for example), intertwined with at least one high-modulus thread (Kevlar®, for example).

Optionally, tyre 1 may also comprise one layer 10 of elastomer material placed between said carcass structure 2 and belt structure 5 consisting of said circumferential coils 5a, said layer 10 preferably extending over a surface substantially corresponding to the extension surface of said belt structure 5.

Alternatively, said layer 10 extends over a lower surface than the extension surface of the belt structure 5, only over opposite side portions thereof, for example.

In a further embodiment, an additional layer of elastomer material (not shown in FIG. 1) is put between said belt structure 5 formed of said circumferential coils 5a, and said tread band 6, said layer preferably extending on a surface substantially corresponding to the extension surface of said belt structure 5. Alternatively, said layer only extends along at least one portion of the extension of the belt structure 5, on opposite side portions thereof, for example.

In a preferred embodiment, at least one of said layer 10 and additional layer comprises short aramidic fibres, Kevlar® fibres for example, dispersed in said elastomer material.

Said carcass structure 2, as above illustrated, is preferably formed of two carcass plies 3, 4. Each of said plies 3, 4 has a plurality of cords such oriented that each of them crosses the equatorial plane of the tyre of the invention preferably at an angle of substantially 90°. In addition, the lying plane of each cord is substantially perpendicular to the equatorial plane X-X of said tyre 1, has an orientation, with respect to a radial plane (R, R′), passing through the crossing point of said cord with the equatorial plane X-X, and forms an angle (α, α′) with said radial plane (R, R′) that is substantially different from 0° (lying angle).

Preferably, the carcass structure 2 is built following the process illustrated in the already mentioned document WO 00/38906. As shown in FIGS. 2A, 2B, a toroidal support 20 is used as the building drum and a plurality of strip-like elements 21a, 21b is used as the constituent elements of said plies, said strip-like elements each having a plurality of cords parallel to each other and oriented in the longitudinal dimension of the strip-like element itself. Each strip-like element 21a, 21b is laid onto said toroidal support 20 in a lying plane (N, N′) perpendicular to said equatorial plane X-X and offset in parallel with respect to a radial plane “P” that, with said radial plane (R, R′), forms an angle equal to the lying angle (α, α′).

In accordance with the present invention, the lying plane (N) of each cord of the first carcass ply 3 and the lying plane (N′) of a corresponding cord of the second carcass ply 4 are offset in parallel on opposite sides with respect to the same radial plane (P).

In this way each cord of the carcass ply crosses the equatorial plane X-X at a point belonging to a radial plane (R, R′) of said tyre, each cord lying in a plane forming an angle (α, α′) with said radial plane different from 0°.

Preferably, the two plies 3 and 4 are such made that angle a formed by the lying plane of any cord belonging to said first ply 3 with said radial plane “R” substantially has the same value, but with opposite sign, as an angle α′ formed by the lying plane of the corresponding cord belonging to said second ply 4 at a radially more external position with the same radial plane “R” (FIG. 2C).

In this way a tyre 1 is obtained that has a two-ply carcass structure which is substantially of the radial type close to the equatorial plane X-X and substantially of the cross-ply type along the sidewalls 7: in a side view or in its development in a plane the carcass structure appears as shown in the previously described FIGS. 3 and 4.

In case of a tyre suitable for use on motorcycles of big sizes, making said carcass structure 2 with the provision of at least three carcass plies could be convenient. In this case it is desirable for the third ply to be made at a radially outermost position with respect to the first and second plies and each cord should have a lying angle preferably of the same sign, and more preferably of the same opening as well, as the lying angle of each cord belonging to the first ply.

In the same manner, a fourth carcass ply can be inserted, in which each cord has a lying angle preferably of the same sign, and more preferably of the same opening, as the lying angle of each cord belonging to the second ply.

Preferably, the strip-like elements of a width included between 5 mm and 20 mm and a thickness in the range of 0.5 mm to 2 mm, contain a number of cords included between 4 and 40, with a density preferably in the range of 60 to 180 cords by decimetre, measured on the carcass ply, in a circumferential direction close to the equatorial plane of tyre 1.

The carcass plies in accordance with the present invention preferably comprise textile cords selected from those usually adopted in building tyre carcasses, made of nylon, rayon, PET, PEN for example, the strand of which is of a diameter included between 0.35 mm and 1.5 mm.

It should be recognised that as an alternative to the strip-like elements, a single continuous cord may be used that, by being suitably laid on said toroidal support in subsequent side by side depositions, obtains said carcass plies 3, 4 with the same geometry. In this case there is no longer a plurality of cords in the strict sense of the word, but a single cord having a plurality of lengths from bead to bead that are joined together, each length being however substantially equivalent to each cord belonging to the strip-like element illustrated above.

Therefore in the present specification and in the following claims by the term “plurality of cords” it is intended both a real multiplicity of cords and a plurality of lengths belonging to the same cord, extending substantially from bead to bead and joined together.

Preferably, each annular reinforcing structure 9 has at least one annular insert made up of a preferably metallic elongated element disposed in substantially concentric coils, each coil being alternatively defined by a length of a continuous spiral or by concentric rings formed of respective thread-like elements.

Preferably, as shown in FIG. 1, two annular inserts 9a and 9b are provided the first of which is made at the end of manufacture of the first carcass ply 3, by winding of said thread-like element with the possible aid of rollers or other suitable devices acting against the action of the axially external surface of said ply 3 built on said toroidal support 20, as illustrated in said document WO 00/38906. The presence of a filler 12 of elastomer material is provided at a position axially external to said first annular insert 9a. At the end of manufacture of the second ply 4, said second annular insert 9b is made in a similar manner. Deposition of a further filler 13 at a position axially external to said second annular insert 9b completes manufacture of said annular reinforcing structure 9.

The constituent material of said thread-like element can be any textile or metallic material or a material of other nature, provided with suitable features of mechanical strength; preferably this material is normal steel or high-carbon steel, preferably employed in the form of a metallic cord.

In a preferred embodiment, the two-ply carcass structure 2 is coupled with a belt structure 5 substantially comprising said coils 5a alone. In addition the two plies 3 and 4 are preferably made as above illustrated, so as to substantially obtain a tyre 1 having a two-ply carcass structure substantially of the radial type in the vicinity of the equatorial plane X-X and substantially of the cross-ply type along the sidewalls 7.

1-17. (canceled)

18. A pneumatic tyre for a two-wheeled vehicle, comprising:
a carcass structure;
a belt structure;
a tread band; and
a pair of sidewalls;
wherein the carcass structure comprises:
at least one first carcass ply; and
at least one second carcass ply;
wherein each carcass ply comprises a plurality of cords disposed substantially parallel to each other,
wherein each carcass ply is shaped in a substantially toroidal configuration,
wherein ends of each carcass ply are engaged with respective circumferential annular reinforcing structures,
wherein the belt structure is disposed at a radially external position relative to the carcass structure,
wherein the tread band is disposed at a radially external position relative to the belt structure,
wherein the sidewalls are disposed on laterally opposite sides relative to the carcass structure,
wherein each cord of the carcass plies:
identifies a radial plane of the tyre passing through an intersection point of the cord with an equatorial plane of the tyre; and
lies in a lying plane substantially perpendicular to the equatorial plane of the tyre and forming a lying angle different from zero with a respective radial plane; and
wherein the lying angle of each cord of the at least one first carcass ply and the lying angle of a corresponding cord of the at least one second carcass ply identifying a same radial plane have opposite signs with respect to that radial plane.

19. The tyre of claim 18, wherein the lying angle of each cord of the at least one first carcass ply and the lying angle of a corresponding cord of the at least one second carcass ply identifying the same radial plane have opposite signs with respect to that radial plane and a substantially same magnitude.

20. The tyre of claim 18, wherein each cord of the carcass plies crosses the equatorial plane of the tyre, forming an angle of substantially 90° with respect to the equatorial plane of the tyre.

21. The tyre of claim 18, wherein the belt structure comprises:
a layer comprising a plurality of circumferential coils;
wherein the circumferential coils are disposed in axial side-by-side relationship, and
wherein the circumferential coils are spirally wound at a substantially zero-degree angle relative to the equatorial plane of the tyre.

22. The tyre of claim 21, wherein the circumferential coils comprise steel cords, and
wherein in a stress-deformation diagram, the steel cords demonstrate a behavior having a percent elongation greater than 0.4%, with a load lower than 5% with respect to a tensile strength of the steel cords.

23. The tyre of claim 22, wherein the percent elongation of the steel cords is greater than or equal to 0.5% and less than or equal to 4%.

24. The tyre of claim 18, wherein the carcass structure comprises at least a first carcass ply, a second carcass ply, and a third carcass ply.

25. The tyre of claim 24, wherein the lying angle of each cord of the first carcass ply and the lying angle of each cord of the third carcass ply have a same sign with respect to a same radial plane.

26. The tyre of claim 25, wherein the lying angle of each cord of the first carcass ply and the lying angle of each cord of the third carcass ply have a substantially same magnitude.

27. The tyre of claim 18, wherein a first layer of elastomer material is interposed between the carcass structure and the belt structure.

28. The tyre of claim 27, wherein the first layer comprises short aramidic fibres.

29. The tyre of claim 18, wherein a second layer of elastomer material is interposed between the belt structure and the tread band.

30. The tyre of claim 29, wherein the second layer comprises short aramidic fibres.

31. The tyre of claim 18, wherein a first layer of elastomer material is interposed between the carcass structure and the belt structure, and
wherein a second layer of elastomer material is interposed between the belt structure and the tread band.

32. The tyre of claim 31, wherein the first layer comprises short aramidic fibres, and
wherein the second layer comprises short aramidic fibres.

33. The tyre of claim 18, wherein each carcass ply comprises a plurality of strip elements, and
wherein each strip element comprises at least one cord.

34. The tyre of claim 18, wherein each annular reinforcing structure comprises:
a first annular insert; and
a second annular insert;
wherein the first annular insert is axially external to the at least one first carcass ply, and
wherein the second annular insert is axially external to the at least one second carcass ply.

35. The tyre of claim 34, wherein each annular reinforcing structure comprises:
a first filler of elastomer material;
wherein the first filler of elastomeric material is axially external to the first annular insert.

36. The tyre of claim 34, wherein each annular reinforcing structure comprises:
a second filler of elastomer material;
wherein the second filler of elastomeric material is axially external to the second annular insert.

37. The tyre of claim 35, wherein each annular reinforcing structure further comprises:
a second filler of elastomer material;
wherein the second filler of elastomeric material is axially external to the second annular insert.
